(19) United States
(12) Patent Application Publication
(10) Pub. No.: US 2011/0287189 A1
(43) Pub. Date: Nov. 24, 2011

(54) Method of the electrode production

(75) Inventors: Elena M. Shembel, Coral Springs, FL (US); Nickolai (Mykola) I. Klyui (Kliui), Kiev (UA); Irina Maksyuta, Dnipropetrovsk (UA); Volodymyr Ivanovich Redko, Coral Springs, FL (US); Tymofiy Pastushkin, Ft. Lauderdale, FL (US); Volodymyr P. Temchenko, Kiev (UA)

(73) Assignee: Enerize Corporation, Coral Springs, FL (US)

(21) Appl. No.: 13/068,480

(22) Filed: May 12, 2011

Related U.S. Application Data
(60) Provisional application No. 61/395,367, filed on May 12, 2010.

(51) Int. Cl. B05D 5/12

(52) U.S. Cl. 427/450; 427/446; 427/453

(57) ABSTRACT

The invention relates to methods of gas detonation deposition (gas detonation explosion) applying coatings, especially layers of materials for electrochemical devices for use as electrodes in electrochemical energy generation and storage devices such as batteries, supercapacitors, photovoltaic cells, and the like. In the method of the gas detonation deposition the powders of the materials, which are deposited, are subjected to detonation with the explosion products flow. As a result, the powder particles gain a high kinetic energy and are deposited on a substrate, forming a high quality coating.

### CROSS-REFERENCE TO RELATED APPLICATION DATA

Provisional Application No. 61/395,367, filed on May 12, 2010

### FEDERALLY SPONSORED RESEARCH

None

### SEQUENCE LISTING

None

### FIELD OF THE INVENTION

The invention relates to methods of applying coatings especially layers of materials for electrochemical devices for use as electrodes in electrochemical energy generation and storage devices such as batteries, supercapacitors, photovoltaic cells, and the like.

### BACKGROUND OF THE INVENTION

The invention relates to chemical power sources and solar cells. In particular, the invention relates to chemical power sources with non-aqueous electrolyte. The positive electrodes of these power sources could be based on lithiated oxides of cobalt, of manganese, and of iron, and the negative electrodes, in which an active substance uses composites, which could be based on graphite. For example, the negative electrode of Li-ion batteries with non-aqueous electrolyte could be based on the composite of the graphite and silicon. Most known technologies for the electrodes production are using the composites of the active material, electronic conductive additive, and binder. Conductive additive provides the conductivity of the electrode mass; the binder provides mechanical strength of the electrode mass and its adhesion to the substrate.

Methods of electrode fabrication, which could ensure the strength of the mass of the electrode without binder, are very promising. Also important is the ability to provide the conductivity of the electrode mass without conductive additives.

One of the most perspective technologies for formation the thin layers of the different material is the gas detonation deposition (GDD). The GDD technology is aimed at creating a new technological generation for producing the coatings that posses unique operating characteristics. In GDD technology the powder of material, which is deposited, is subjected of action of the plasma or detonation products flow. As a result, the powder particles gain a high kinetic energy and are deposited on a substrate, forming a high quality coating. The coating, which has the required properties, can be obtained by varying the chemical composition of initial powders, gas mixture, flow energy, etc.

The main advantages of GDD method are as follows:
high productivity and opportunity of obtaining the coatings on substrates of large area (up to a few square meters);
opportunity to deposit a layer of various thickness (from a few micrometers to millimeters);
a chance to change the deposited layer composition and its porosity over a wide range;
low substrate temperature during the GDD process (less then 100° C.) that makes it possible to deposit the layers of the materials on the polymer substrate or low-melting-point metal substrates;
low cost and low power-consuming, high productivity of GDD equipment, and, as a result, low cost price of the fabricated layers;
possibility to vary the GDD process parameters and obtain the layers possessing the required properties;
high adhesion of deposited layer to substrate.

The GDD method also enables one to vary and monitor the electrode structure (single or multilayer with required distribution of phase composition), chemical composition of the materials, which are obtained, porosity of the functional layer, etc. Besides, this technology provides an excellent adhesion of carbon material to the metal current collector. It is important to emphasize once more that layers can further be modified by using the post-deposition treatment.

### BRIEF DESCRIPTION OF THE INVENTION

Known methods of the deposition of electrode materials do not provide the possibility to obtain the electrode layers with desired properties. It is because known methods do not allow obtain the targeted form the structure of the electrode material, and the morphology of the surface, to provide the necessary adhesion between the electrode material and the metal substrate—current collector, and do not provide required electrochemical properties of the electrode.

The purpose of this invention is fabrication the electrodes layers with high-speed forming, high specific charge-discharge characteristics, good adhesion to the substrate, and low cost.

The problem is solved by the fact that the method of producing the layer of electrodes for battery, is characterized in that in order to improve the performance of the method, to improve the adhesion layer to the substrate, and the electrochemical characteristics of electrodes, the layers of electrode material are formed using the gas detonation deposition, and this method does not require lengthy procedures for processing the initial powders, and the layers, which obtained; and after deposition of the layers the treatment of the layers with a high plasma or high-temperature annealing, chemical or electrochemical etching, depending on the type of material is followed.

### BRIEF DESCRIPTION OF DRAWINGS

FIG. 1. Schematic design of the setup for realization the method of deposition, using the gas detonation.

FIG. 2 Work timing diagram of setup for gas detonation deposition.

FIG. 3. Profilograms of the surface of a stainless steel substrate after treatment using abrading particles of silicon carbide. Slope profilograms is caused due the deflection of the plate.

FIG. 4. X-ray diffraction patterns of the carbon based coatings (80% graphite+20% silicon in initial powder), which was deposited onto nickel substrate. Figures denote corresponding crystallographic index.

FIG. 5 X-ray diffraction patterns of carbon based coatings (80% graphite+20% silicon in initial powder), which was deposited onto stainless steel substrate. Figures denote corresponding crystallographic.

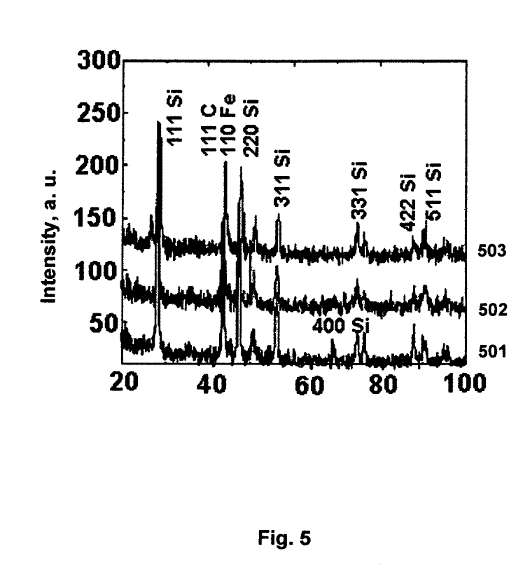

FIG. 6. Dynamics of change the discharge capacity of the electrode based on carbon-silicon composition. The electrode layer was obtained by gas detonation deposition (gas detonation explosion). Electrode was modified by heat treatment Electrode mass composition includes 80 mass % of graphite and 20 mass % of silicon (Si). The weight of the active material is 0.0011 g. Electrolyte is EC, DMC, LiClO4. Discharge and charge currents are 0.1 mA/cm2.

FIG. 7. Dynamics of change the charge (701) and discharge (702) capacity of the electrode based on carbon-silicon composition. The electrode layer was obtained by gas detonation deposition (gas detonation explosion). Electrode was modified by heat treatment. Electrode mass composition includes 90 mass % of graphite and 10 mass % of silicon (Si). The weight of the active material is 0.0019 g. Electrode area is 15 cm². Electrolyte is EC, DMC, and LiClO4. Discharge and charge currents are 1.5 mA/cm².

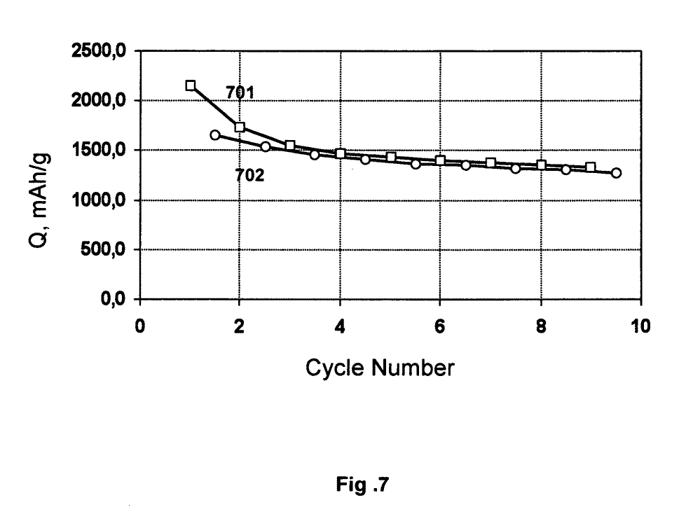

FIG. 8. Charge and discharge characteristic of the electrode based on carbon-silicon composition. The electrode composition was obtained by gas detonation deposition (gas detonation explosion). Electrode was modified by heat treatment. Electrode mass composition includes 90 mass % of graphite and 10 mass % of silicon (Si). The weight of the active material is 0.0019 g. Electrode area is 15 cm². Electrolyte is EC, DMC, LiClO₄. Discharge and charge currents are 1.5 mA/cm². Numbers on the curves correspond to the cycle number

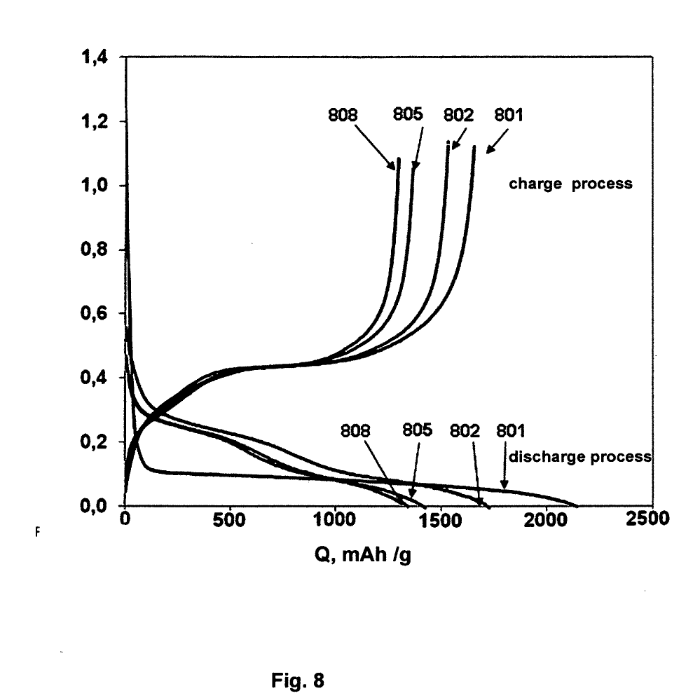

FIG. 9. Charge (901) and discharge (902) characteristic of the electrode based on carbon-titanium oxide composition. The electrode composition was obtained by gas detonation deposition (gas detonation explosion). Electrode mass composition includes 80 mass % of graphite and 20 mass % of titanium oxide (TiO₂). The weight of the active material is 0.0226 g. Electrode area is 2 cm². Electrolyte is EC, DMC, LiClO₄. Discharge and charge currents are 2 mA;

### DETAILED DESCRIPTION OF THE INVENTION

Method, which is claimed in this invention, is a method of gas detonation deposition (gas detonation explosion) with subsequent processing of the obtained layers in the frequency plasma or high-temperature annealing, chemical or electrochemical etching, depending on the type of material, which is deposited.

In specification, which is presented below, a detailed description of the invention is presented using the example of the electrode, which is a composite material of carbon and silicon. This electrode is particularly promising for use as an anode in lithium ion batteries.

At the same time in the examples and the tables below, presents data that confirm the possibility to use the invention for other anode and cathode materials for power sources, and also the material for solar cells.

The properties of the anode to a large extent affect on the specific discharge characteristics of lithium batteries, in particular, its specific energy per unit weight and unit volume, cycle life, self discharge, and other.

Efficiency of the work of lithium electrode in the secondary batteries is limited by the formation of passivating layers and dendrites, which significantly affects the quality of sludge during the charge process, and reduces the efficiency of cycling. In addition, dendrites, which could accompany the deposition of lithium, create an increased risk for cycling due to short circuits.

Intercalation compounds of lithium with carbon possess good reversibility during the cycling of the Li-ion batteries. However these compounds have a low specific discharge capacity and energy per unit weight. Specific charge-discharge characteristics of electrodes based on graphite or other modification of the carbon are limited by the theoretical limit of 372 Ah/kg.

One of the ways to enhance specific discharge characteristics of anodes based on graphite or other carbon modifications is to use following composition: graphite-silicon; graphite-lead; graphite-tin, and other. Carbon-silicon composite material has a high theoretical specific energy per volume, and per weight, because the silicon has high energy parameters.

At the same time for the composite structures of the graphite-silicon one of the problems is to change the mechanical strength during cycling. This problem is caused by a significant increase the volume of the silicon during intercalation of lithium into the silicon structure when the charging process takes place.

Thus, when receiving the electrodes on the based on composite graphite-silicon it is important to form a structure that would provide high mechanical strength combined with high electrochemical characteristics. In this case, the most important task is to develop methods of forming sufficiently thin layers of active substance on the metal substrates.

The disadvantages of these methods should, first and foremost, include the low specific characteristics of layers, which is due to a highly disordered or even the amorphous structure of the films. Furthermore, the presence of significant internal stresses in films of carbon limits their critical thickness values of a few micrometers.

Necessity to use the vacuum equipment limits the size of electrode which will be received, by a size of the equipment for vacuum deposition. On the other hand, these solutions require significant investment of time, due to the necessity of loading substrates into the vacuum chamber, providing a working vacuum, and a sufficiently long deposition process to produce layers of at least a several microns thick.

There is a way to create a layer of the graphite electrode on a metal substrate, which is based on thermal (pyrolytic) destruction of graphite materials and deposition of the graphite layer with a high degree of crystallinity of the metal substrate. A disadvantage of this method is the inability to obtain the electrode layers with charge-discharge characteristics higher than the theoretical limit for crystalline graphite because with the increase of crystallinity of graphite the electrochemical characteristics decrease.

In addition, the graphite layer, which is obtained by this method, has low adhesion to metal substrate. This is characteristic of pyrolytic deposition methods, and this limits the scope of the resulting electrode structures. Particularly negative affect of low adhesion of the graphite layer to the metallic substrate is shown on the characteristics in the case of electrode with roll type structure. The elements of roll type require substantial curvature of the bending of the electrode and, accordingly, are required ensuring a good adhesion of the coating to the substrate to prevent delaminating of the active layer.

The literature describes a process which uses a mixture of silicon particles and polyvinyl chloride (PVC), followed by heat treatment in argon for 1 hour, grinding in a ball mill for 2-10 hours, and forming an electrode in accordance with the following procedure:
mixing of obtained active material (80 wt. %) with the acetylene carbon black (8 wt. %), and the binder polyvinylidene fluoride (PVDF) (12 wt. %).
the resulting mixture then homogeneously stirred in solution 1-metil-2-pirolidon (NMP),
the resulting slurry coated on a nickel substrate, and dried at a temperature of 120° C. in a vacuum.

The maximum specific discharge capacity of ˜900 mAh/g was obtained within 40 cycles.

Disadvantages of this method include as following: very complex and lengthy procedures for the preparation of initial powders and the formation of electrodes, the need for complex reagents, procedures and vacuum thermal treatments and, consequently, low productivity and high cost of received electrodes

The literature also describes the mechanochemical methods of obtaining of negative electrodes for lithium batteries based on the graphite and silicon composite. When using such methods the mixture of the powders of the graphite and silicon in various ratios have placed in a ball mill and have milled in an atmosphere of pure argon for 150 hours.

The resulting mixture is added to the suspension of the binder polytetrafluoroethylene (PTFE) in dehydrated alcohol. Mixture, which is prepared, then is applied to metallic substrate, such as nickel, with a rough surface (“foam nickel”). After that, the electrode is dried, pressed and dried again at 150° C. in vacuum overnight. In some examples, the total mass of the active ingredient was 16 mg.

For the comparison, the results of manufacturing the electrode of a mixture of graphite (60 at. %) and silicon (40 at. %) when using the same procedure without grinding inside a ball mill are presented in technical literature.

The maximum discharge specific capacity of electrodes, which were prepared from powders of the milled graphite (80 at. %) and the silicon (20 at. %) totaled about 1000 mAh/g in the first 4 cycles of charge-discharge, and then decreases to around 400 mA*h/g at the 20th cycle. For the electrodes based on the powders of the graphite and silicon, which did not grinded inside a ball mill, the discharge capacity does not exceed 200 mAh/g. These results clearly confirm the influence of structure on the characteristics of the composite electrodes.

The main disadvantages of mechanochemical methods are as follows:
The need for complicated and lengthy procedures preliminary preparation of powders (grinding in a ball mill for tens to hundreds of hours), a multistage and time-consuming procedure of thermal treatment of the initial mixture and the electrode on the metal substrate. As a result, method is quite expensive, has low productivity because requires a long time (tens of hours to several days);
Poor adhesion of these layers to the substrate, which leads to delaminating of the active layer from the substrate due to changes in volume of the active layer during cycling. In addition, area of application of this electrode structures is limited, for example due the problem to use these electrode structure in roll-type batteries, which require a high curvature of the bending of the anode;
Insufficiently high and stable specific characteristics of the electrode, due to the large number of grain boundaries in the layer, which is formed from the powder, which is subjected to grinding for a long time.

The objective of the present invention is to forming electrodes based on composite materials with a high rate of formation, the high specific charge-discharge characteristics, excellent adhesion to metal substrates which is the conductor of the current, and low cost. In particular, the object of the invention is to provide composite electrodes based on silicon.

The problem is solved by the fact that for the production of the electrode for lithium batteries on the surface of the metal substrate, the method based on the gas detonation deposition is used. This method allows to form the layers of the active materials by deposition of particles of the powder of a various composition and size on the substrate.

The method is characterized in that in order to improve the performance of the method, to improve the adhesion of the layer of active electrode material to the substrate, the electrochemical characteristics of the electrode based on the layer of active material, and a cycling efficiency of a power source with electrodes which is based for example on the composite of the graphite and silicon, this composite is formed by using gas detonation deposition that does not require time-consuming processing of the initial powders and the layers, which are obtained.

The layer of deposited material undergoes further processing in the high-frequency plasma or high-temperature annealing, chemical or electrochemical etching depending of the type of the materials, for examples, the type of the graphite.

The electrode active material in accordance with the current invention could comprises a composition of graphite and silicon with a silicon content 1-90 wt. %.

The metal oxides MexOy or their composites MexIMeyIIOz (Me=Ti, Sn, Ag, V, Mn . . . ), as well as the micro- or nanoparticles of metals could be added to the composite of the graphite and silicon.

The layers of the active electrode materials could be deposited on the substrate that includes the metal base, or on the substrate that includes the metal base and a fixed metal grid.

The method of the gas detonation deposition, which is presented in the current invention, could be used for the forming layers of the different types of the active materials. Examples of using this method for the forming the layers of different electrode materials are presented below in tables.

The essence of the method of the gas detonation deposition, which is presented in the current invention, is as follows: the layers of deposited active material are formed by deposition of particles of the powder of a various composition and size on the substrate when the process of the deposition of these particles is accelerated by detonation wave.

The detonation wave arises as a result of ignition of an explosive mixture of oxygen and combustible gas such as hydrogen, acetylene and propane-butane, which are in the specified proportion in the explosive chamber. Wave propagates in the detonation gun barrel where a portion of the powder of the active deposited material is introduced. The particles of the materials are accelerated to speeds equal ˜5M (M—Mach number), and as results acquire the considerable kinetic energy.

As a result of physico-chemical interaction of the particle of the active materials with the substrate material a continuous coating on the basis of the starting material is formed.

The forming of the coatings on substrates of large area is achieved either by moving of the detonation gun relative of substrate, or by moving the substrate relative to the gas detonation gun.

Significant advantages of the method of gas detonation deposition, which is present in the current invention versus a well-known methods of the forming the electrode structures, are as follows:

1. The high performance of the method, due to the following:
the method does not require lengthy preparation process procedures for the powders and the substrates before deposition;
a method provides a high speed coating formation, which, depending on the type of powder can reach for example the following values of 0.1-0.5 cm 2/s at a coating thickness of 40-100 microns;
the method does not require after the deposition the additional long-term treatment of coated layers, which are deposited.
   2. The high adhesion of the coated layers of the active electrode material to the substrate; which provided due the following: high speed of the particles, which are deposited, their physical-chemical interaction with the substrate material, and the formation of transition layers at the interface of the coating-substrate. An additional increasing in adhesion can be achieved by treatment of the substrate with the abrasive powder using the gas detonation method before the deposition of the active layers. As result, the rough surface of the substrate is formatted (roughness depends on the size of the abrasive particles), and effective surface coverage of interaction of the active materials with the substrate is increased.
   3. Deposition of coatings is carried out in air or inert gas flow, i.e. eliminates the need for vacuum chambers and pumping systems.
   4. The relative simplicity and low cost. In the method of gas detonation deposition cheap industrial gases (oxygen, propane, butane, acetylene, and hydrogen) are used.

Power consumption is only required for the support of the electromagnetic gas valves, compressors, engines, systems, to move the gun control unit, and is minimal. The total power consumption does not exceed 1 kW for the rate of deposition which is presented above.

5. Possibility of deposition of coatings on large areas of the substrate. This is achieved either by moving of the detonation gun relative of substrate, or by moving the substrate relative to the gas detonation gun. The area of coverage can reach units m2. When using the regime of the roll moving of substrate material, the size of working surface, on which the deposition of the electrode material, is practically unlimited.
6. The possibility of a wide range change the parameters of the process of gas detonation deposition; this provides the possibility of varying the characteristics of coatings, and obtain active layers with desired properties

The main parameters of the process of gas detonation deposition, which may vary depending on the tasks, are as follows:
composition of the explosive mixture;
the frequency of cycles of process of gas detonation deposition
the distance between the outlet of the gas detonation gun and substrate;
magnitude of gas transport flow, which determines the amount of powder, which must to be introduced in each cycle of the detonation wave
place, where the powder is supplied, and which determines the residence time of powder particles in the detonation wave, and hence their speed and temperature.

In the case of composite of the active material, such as active materials of the electrodes of Li-ion batteries, the active material is produced in the form of a continuous coating, which can have multiple versions of compositions of tracks:
composition of graphite and silicon;
composition of graphite and silicon with the inclusion of micro- or nano particles of metals, for example. Ni or Cu;
oxides or sulfides of metals or their composites, such as LiMn₂O₄, LiFePO₄, LiCoO2, LiMnPO₄, TiO₂ [symbol] SnO₂, FeS₂, CFx with the inclusion of micro- or nano particles of metals, for example. Ni or Cu;

The thickness of the electrode can reach 150 microns. The structure of the electrode allows provide the bending without breaking the contact between the active mass and current collectors in the range of bending radius from 500 microns to 5 mm.

In addition, useful new features are added to the invention which is presented here, if the quantity of active material of the anode is increased by the use of substrate mounted on a metal grid. Metal mesh can increase the number of active material, while maintaining high mechanical strength of the electrode.

Undertake additional heat treatments after the coating process of gas detonation deposition allows optimizing their structure in the direction of regulating the crystallinity of the active layer.

Chemical or electrochemical processing of electrode layers, which are deposited, allows optimizing the morphology of the electrode surface, for example, to increase the porosity of the surface of the electrode layer. As a consequence, the properties of the interface electrode-electrolyte are improved. This is especially important in the manufacture of current sources with a solid electrolyte, which is deposited by vacuum deposition onto the electrode surface. The increasing of the porosity of the surface of the electrode layer allows of the vapor of solid electrolyte to penetrate into the pores of the electrode material. Vapor of solid electrolyte is uniformly distributed into the volume of layer of the electrode before cooling down and then passing into the solid phase.

Conducting plasma treatment in a hydrogen atmosphere, contribute to the additional cleaning of the electrode surface and improving its electrochemical properties. In addition, due the hydrogen diffusion along grain boundaries, the passivation of the energy traps at these boundaries is carried out, which further improves the quality of the electrode, for example, the anode lithium ion battery based on a composition of silicon and carbon.

During the deposition of anodic layers, which is based on the composition of the graphite and silicon, the substrate temperature does not exceed 80° C. However, depending on the type of substrate the temperature could be reduced using the cooling, or increased due to additional heating.

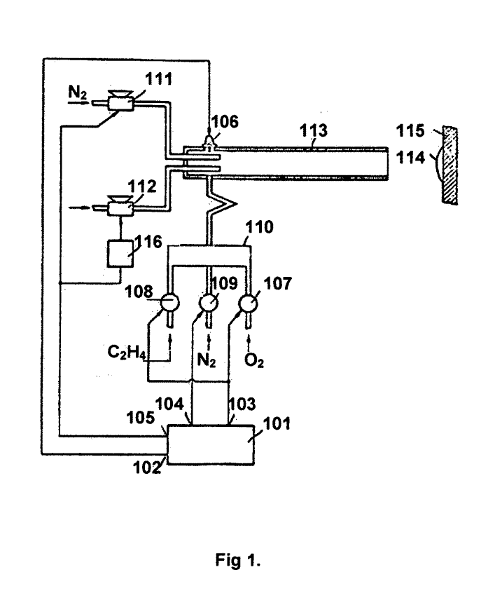

Process of the deposition, which is based on the gas detonation, involves several steps that are repeated in each cycle of deposition. These steps include
filling a barrel of a detonation gun blast chamber with an explosive mixture (113 on the FIG. 1) with an explosive mixture through valves (107 and 108 on the FIG. 1);
cutting off of the explosive mixture with inert gas;
applying the powder of the substance to be deposited on the substrate through batchers (111 and 112 on the FIG. 1);
igniting the explosive mixture by a candle, and the explosion of the explosive mixture (106 on the FIG. 1);
purging a gun barrel using the neutral gas through one of the valves (109 on the FIG. 1).

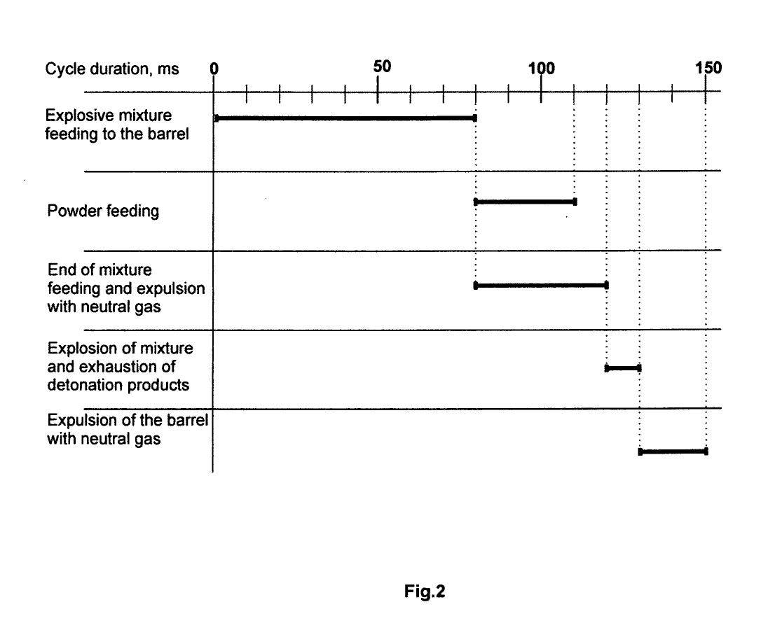

Management of the process of the deposition, which is based on the gas detonation, is carried out by the control unit (101 on the FIG. 1). The time of the intervals, which are describing the stages of the process of the deposition, which is based on the gas detonation, are shown in sequence diagram (FIG. 2).

The treatment of the surface of the substrate with abrasive powder using the gas detonation method could be held for increasing the efficiency of the process of the deposition of the active electrode material on a metallic substrate. As example the silicon carbide could be as the abrasive powder.

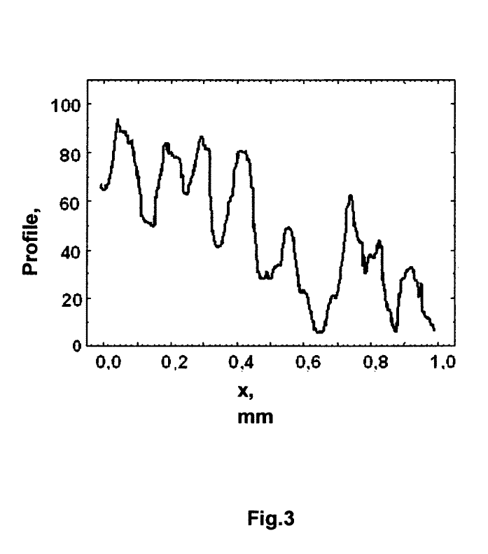

As an example, in FIG. 3 shows the measured surface roughness of stainless steel after abrasive machining of silicon carbide particles with a grain size <40 microns. Measurements have been conducted using the profilometer. Relief, which was formed after this treatment, has a size of about 50 microns.

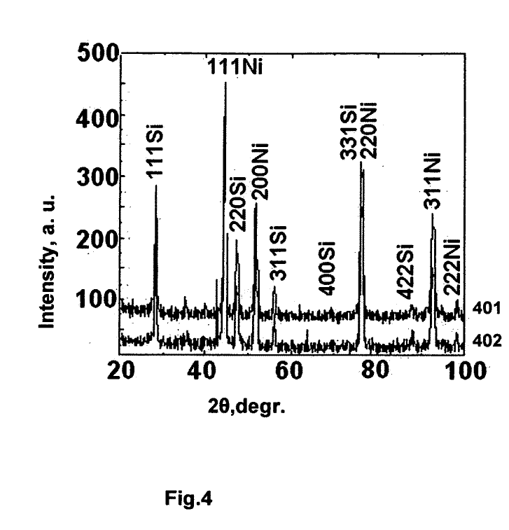

For electrodes based on carbon-silicon composites, obtained using the technology presented in this patent application, the crystalline structure of raw materials is preserved. This is evidenced by the presence of peaks characteristic of graphite and silicon on the X-ray diffraction spectra of coatings (FIG. 4, 5).

As an example, in the present invention the electrodes based on graphite and silicon, as well as composites of the graphite and silicon (C—Si) with the addition of metal oxides or metal micro- or nanoparticles, obtained by the method of the gas detonation deposition are presented. Electrodes, which are fabricated by this method, have high specific characteristics when used as anodes in lithium ion batteries.

Useful advantages of this method and of the electrodes based on the composition of the graphite and silicon, which are obtained by this method, are as follows:
the method is inexpensive and expeditious as does not require of the long technological procedures for the preparation of powders, substrates, processing of the electrodes, and provides a high rate of formation of the active layer;
the electrodes, which are obtained using this method, possess high mechanical strength and adhesion to the metal substrate;
the electrodes which are obtained, are characterized by high specific charge and discharge characteristics when used as anodes in Li-ion batteries.

The main factors that affect the structure, mechanical and electrochemical properties of the layer of electrode material, are as follows:
parameters of the process of the deposition based on the gas detonation
   amount of material, which is injected into the detonation wave;
   composition of the explosive mixture;
   the frequency of cycles of process of gas detonation deposition;
   the distance between the outlet of the gas detonation gun and substrate;
   the place, where the powder is supplied, and which determines the residence time of powder particles in the detonation wave, and hence their speed and temperature
composition and dispersion of the initial powder of the active materials;
temperature of the substrate during the process of the deposition

### EXAMPLES

The Examples described below are provided for illustration purposes only and are not intended to limit the scope of the invention.

The following examples describe the novelty, practical value, and non-obviousness of the claimed invention.

### Example 1

1. The substrate of the stainless steel is placed in the device for conducting the deposition of the active materials using the method of gas detonation. The diameter of the substrate is 20 mm
2. The surface of the stainless steel substrate is subjected to abrasive machining using the method of gas detonation with the silicon carbide particles. The size of the particle is less then 40 microns. In the resulting of this process on the surface of the substrate the relief is formed with profile of 50 mm.
3. The mixture of the powder of the graphite (80%) and silicon (20%) is loaded in the batcher of the device.
4. Then process of the deposition of the active layers, which is based on the composition of the graphite and silicon, was conducted under the following conditions:
the distance between the outlet of the gas detonation gun and substrate was 10 cm;
the frequency of the cycles of the deposition process based on the gas detonation was 6 Hz;
the ratio of the combustible gas (propane-butane) and oxidizer (oxygen) was 1:10

Analysis of the layer of the active materials, which was deposited, has shown its high adhesion to the substrate.

Investigation of electrochemical properties of the layer, which was deposited, showed that there is a gradual decrease in specific discharge capacity values up to ˜800 mAh/g at the 50th cycle of charge-discharge while maintaining its trend towards further reduction.

### Example 2

According to the procedure, which is described in Example 1, a layer of the composition of the graphite (90%) and silicon (10%) was obtained. The layer, which was obtained, was subjected to ion-plasma treatment

The ion-plasma treatment was conducted under the following conditions:

The sample was placed in the vacuum system, and the high-frequency processing was conducted under ambient temperature:
at 13.56 MHz
in argon plasma discharge power at 250 W,
under argon pressure of 100 Pa for 10 minutes,
   then
in hydrogen plasma in the discharge power 250 W,
under hydrogen pressure of 100 Pa in for 15 minutes

Analysis of the electrochemical properties of this layer showed that there is a gradual decrease in the specific discharge capacity. At the 80th cycle the value of the specific discharge capacity was 600 mAh/g. Then was a gradual decreasing of the discharge capacity to the constant value 500 mAh/g at the 150th charge-discharge cycle.

### Example 3

According to the procedure, which is described in Example 1, a layer of the composition of the graphite (80%) and silicon (20%) was obtained, i.e. with increased silicon content.

The layer, which was obtained, was subjected to ion-plasma treatment according to the procedure, which is described in Example 2.

Analysis of the electrochemical properties of this layer showed that there is a gradual decrease in the specific discharge capacity with a gradual saturates at a value of 750 mAh/g at the 80th cycle of charge-discharge

Thus, increasing the silicon content in the composition of the layer graphite-silicon, which was deposited using the method of gas detonation, improves the electrochemical characteristics of the electrode.

### Example 4

According to the procedure, which is described in Example 1, a layer of the composition of the graphite (90%) and silicon (10%) was obtained.

The layer, which was obtained, is subjected to heat treatment in a special furnace in air at 350° C. for 60 minutes.

Analysis of the electrochemical properties of the layer, which was obtained, showed that there is a gradual decrease of the specific discharge capacity values up to 750 mAh/g for a 100 cycle charge-discharge. From the slope of the specific discharge capacity via the number of cycles can be seen that the trend towards further reduction is preserved

### Example 5

According to the procedure, which is described in Example 1, a layer of the composition of the graphite (80%) and silicon (20%) was obtained, i.e. with increased silicon content.

The layer, which was obtained, is subjected to heat treatment according to the procedure, which is described in Example 4.

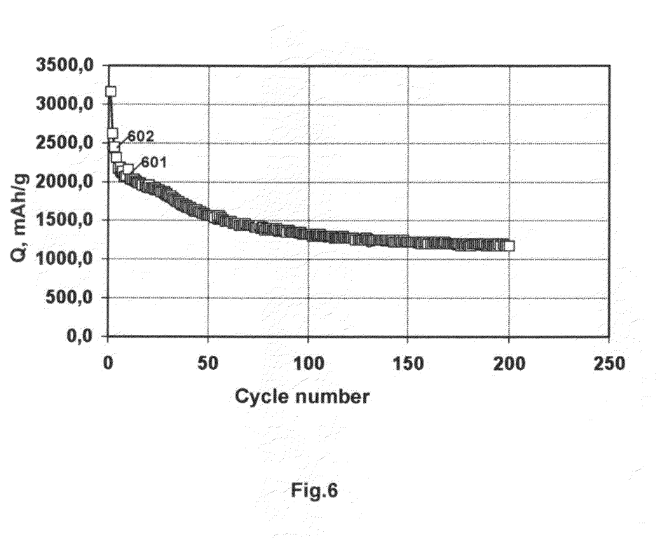

Analysis of the electrochemical properties of the layer, which was obtained, showed that there is a gradual decrease of the specific discharge capacity values up to 1200 mAh/g for a 150 cycle charge-discharge. (FIG. 6) From the slope of the specific discharge capacity via the number of cycles can be seen that the trend towards further reduction is preserved.

This value is maintained until the 200th cycle, indicating the high stability of the electrochemical properties of the layer, which was obtained in accordance with the parameters, presented in Example 4.

This confirms the conclusion of Example 3 that the increasing the silicon content in the composition of anode can improve the electrochemical characteristics of anode. Heat treatment of these layers, which have been obtained using the method of gas detonation, allows obtaining of the anodes with very high and stable characteristics.

### Example 6

According to the procedure, which is described in Example 1, a layer of the composition of the graphite (80%) and titanium dioxide, TiO2 (20%) was obtained. I.e. the silicon is replaced with the titanium dioxide.

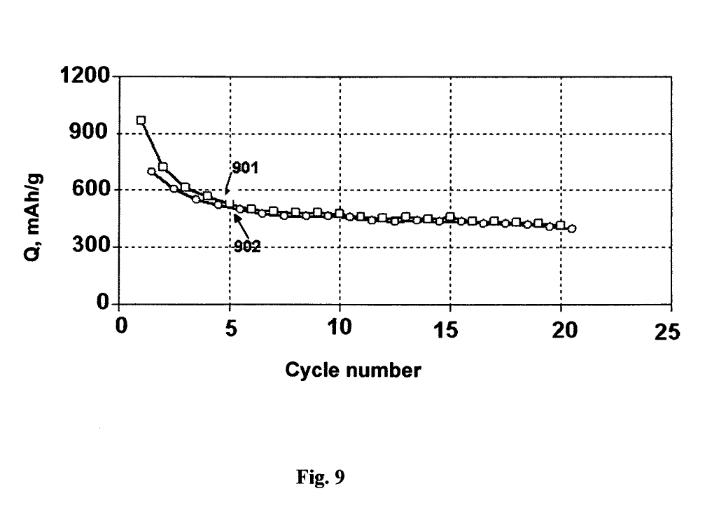

Analysis of the electrochemical properties of this layer showed that after decreasing the specific discharge capacity values at the 5th cycle of charge-discharge up to 400 mAh/g, in the following cycles this value is stored to the 20th cycle. This demonstrates the high stability of the characteristics of the layer, which was deposited using the method of the gas detonation. (FIG. 9).

This value of the specific discharge capacity is significantly higher than achieved for pure graphite (372 Ah/kg) or titanium dioxide.

The weight of the layer, which was deposited in accordance with Example 6, was 23 mg. This is more than an order of magnitude higher than the values obtained in Examples 1-5. This indicates a high density of the resulting material. Last allows significantly increase the values of the energy, which could be accumulated by this electrode.

Examples, which are presented above, are illustrated by results, which are presented in Tables 1 and 2, and the Figures.

TABLE 1
Characterization of electrodes, obtained by gas detonation explosion
Size of substrate 55 mm × 31 mm. The area of the deposited layer 52 × 27 mm

| | | | | |
|---|---|---|---|---|
| | | | | Weight of |
| | | Weight of substrate | | materials, |
| | Weight of | with material, | Composition of deposited | which |
| No. n/n | substrate, g | which deposited, g | materials | deposited, g |

Substrate from the aluminum

| | | | | |
|---|---|---|---|---|
| 1 | 0.8143 | 1.1194 | LiCoO₂ | 0.3051 |
| 2 | 0.8419 | 1.0192 | FeS₂ | 0.1773 |
| 3 | 0.8337 | 0.9320 | MnO₂ | 0.0983 |

Substrate from the copper

| | | | | |
|---|---|---|---|---|
| 2 | 2.6810 | 2.6872 | Graphite GCM, 90% mass + | 0.0062 |
| | | | Si, 10% mass %. Deposition | |
| | | | on one side | |
| 3 | 2.6480 | 2.6625 | Graphite GCM, 90% mass + | 0.0145 |
| | | | Si, 10% mass. Deposition on | |
| | | | two sides | |
| 4 | 2.7785 | 2.7863 | Graphite GCM, 90% mass + | 0.0078 |
| | | | Si, 10% mass. Deposition on | |
| | | | one side | |
| 6 | 2.7604 | 2.7723 | Graphite GAK 90% mass, + | 0.0119 |
| | | | Si, 10% mass.. Deposition on | |
| | | | one side. | |
| 5 | 2.7776 | 2.7923 | Graphite GAK 90 mass % + | 0.0147 |
| | | | Si, 10 mass %. Deposition on | |
| | | | two sides. | |
| 7 | 2.7260 | 2.7386 | Graphite GAK 90 mass % + | 0.0126 |
| | | | Si, 10 mass %. Deposition on | |
| | | | one side. | |
| 8 | 2.7945 | 2.8205 | Graphite GAK 90% mass. + | 0.026 |
| | | | Si, 10 % mass. Deposition on | |
| | | | two sides. | |
| 9 | 2.7592 | 2.7848 | Graphite GAK 90 mass % + | 0.0256 |
| | | | Si, 10 mass %. Deposition from | |
| | | | two sides. | |

Substrate from stainless steel

| | | | | |
|---|---|---|---|---|
| 2 | 1.1484 | 1.3188 | FeS₂ | 0.1704 |
| 3 | 1.1311 | 1.2564 | MnO₂ | 0.1253 |

TABLE 2
Characterization of electrodes, obtained by gas detonation explosion
Frequency of shots-6 shots per a second

| | | | Weight of | | |
|---|---|---|---|---|---|
| | | | the Substrate/ | Weight of the | |
| # electrode | | | electrode | electrode | Weight |
| time | Electrode | Electrode | current | collectors | of electrode |
| of deposition | composition | size | collector | and mass | mass |
| #112 | Graphite GCM, | Coin | 0.3905 | 0.3918 | 0.0013 |
| 20 seconds | 80% | D-16 mm | SS | | |
| | Si, 20% | | | | |
| #118 | Graphite GCM, | Coin | 0.4195 | 0.4212 | 0.0017 |
| 20 seconds | 80% | D-16 mm | SS | | |
| | Si, 20% | | | | |
| #117 | Graphite GCM. | Coin | 0.3860 | 0.3883 | 0.0023 |
| 20 seconds | 80% | D-16 mm | SS | | |
| | Si, 20% | | | | |
| #161 | Graphite GCM, | Coin | 0.4340 | 0.4351 | 0.0011 |
| 10 seconds | 90% | D-16 mm | SS | | |
| | Si, 10% | | | | |
| #210 | Li₄Ti₅O_{12.}, 70% + | Coin | 0.3900 | 0.3910 | 0.0010 |
| 5 seconds | graphite, | D-16 mm | SS | | |
| | 30% C | | | | |
| #230 | FeS2 | Coin | 0.3855 | 0.4382 | 0.0527 |
| | | D-16 mm | SS | | |
| #7 | Graphite GCM, | Coin | 0.3971 | 0.4028 | 0.0057 |
| 40 seconds | 80% + | D-16 mm | SS | | |
| | Si, 10% + | | | | |
| | TiO2, 10% | | | | |
| #33 | MnO2, 90% + | Coin | 0.181 | 0.1952 | 0.0141 |
| 20 seconds | Graphite, 10% | D-16 mm | Al | | |
| #10 | Graphite GCM, | 31*54 | 2.7312 | 2.7692 | 0.038 |
| 60 seconds | 80% + | mm | Cu | | |
| scanning | TiO2, 20% | | | | |
| #11 | Graphite GCM, | 31*54 | 2.7734 | 2.7945 | 0.0211 |
| 60 seconds | 80% + | mm | Cu | | |
| scanning | Si, 20%, | | | | |
| #12 | Graphite GCM, | 31*54 | 2.6894 | 2.7348 | 0.0454 |
| 60 seconds | 80% + | mm | Cu | | |
| scanning | Si, 10% + | | | | |
| | TiO2, 10% | | | | |
| #9 | FeS2, 90% + | 31*54 | 0.8467 | 0.9292 | 0.0825 |
| 60 seconds | graphite, 10% | mm | Al | | |
| scanning | | | | | |

### CLOSURE

While various embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A method of forming an electrode having a metal substrate for at least one of rechargeable lithium batteries, ultracapacitors and solar cells to improve adhesion of active electrode material to the substrate, electrochemical characteristics of the active material, and a cycling efficiency of a power source, to form a layer of the active material by using gas detonation deposition whereby the layers of deposited active material are formed by deposition of particles of the powder of a various composition and size on the substrate and accelerating the deposition by detonation wave, obtained as result of ignition of an explosive mixture with the layer of deposited material undergoes further processing in a high-frequency plasma or high-temperature annealing, chemical or electrochemical etching, depending on the type of source material, said method comprising the steps of:
filling a barrel of a detonation gun blast chamber with an explosive mixture through valves;
cutting off of the explosive mixture with inert gas;
applying the powder of the substance to be deposited on the substrate through batchers;
igniting the explosive mixture by a candle to explode the explosive mixture; and
purging a gun barrel using the neutral gas through one of the valves.

2. A method as set forth in claim 1, wherein the layer of electrode active material comprises a composition of graphite and silicon with a silicon content 1-90 wt. %

3. A method as set forth in claim 1 wherein, the layer of the electrode active material contains metal oxides MeₓO_{y} and their composites: LiMeₓ^{I}Me_{y}^{II}O_{z} (Me=Ti, Sn, Ag, V, Mn . . . ).

4. A method as set forth in claim 2, including the step of adding metal oxides MexOy or their composites MexIMeyIIOz (Me=Ti, Sn, Ag, V, Mn . . . ) to the composite of the graphite and silicon

5. A method as set forth in claim 2, including the step of adding micro- or nanoparticles of the metals to the composite of the graphite and silicon.

6. A method as set forth in claim 1, wherein the detonation wave arises as a result of ignition of an explosive mixture of oxygen and combustible gas such as hydrogen, acetylene and propane-butane.

7. A method as set forth in claim 1, wherein the rate of formation of the coating reaches the values of 0.1-0.5 cm2/s at a coating thickness of 40-100 microns.

8. A method as set forth in claim 1, wherein prior to the deposition of the active electrode material on a metallic substrate the treatment of the surface of the substrate with abrasive powder using the gas detonation method is held.

9. A method as set forth in claim 1, wherein the active electrode layer is deposited on the substrate that includes a solid metal base and a fixed metal grid.

10. A method as set forth in claim 1, wherein the deposition of electrode material on a metallic substrate in a roll mode of motion of the metallic substrate is carried out by moving of the gas detonation gun relative of substrate or by moving the substrate relative to the gas detonation gun.

11. A method as set forth in claim 1, wherein the plasma treatment of the surface of the deposited material is carried out in the atmosphere of hydrogen for the additional cleaning of the surface of the electrode.

12. A method as set forth in claim 1, wherein the deposition of the layer of the active electrode materials is carried out in air or inert gas flow with the goal to eliminate the need for vacuum chambers and pumping systems.

13. A method as set forth in claim 1, wherein during the deposition of electrode layers on the substrate temperature is controlled using cooling or heating of substrate.
